(19) United States
(12) Patent Application Publication
(10) Pub. No.: US 2008/0131077 A1
(43) Pub. Date: Jun. 5, 2008

(54) Method and Apparatus for Skipping Commercials

(76) Inventors: Richard Earl Jones, Plainfield, IN (US); Piero Andreas Madar, Indianapolis, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/795,619

(22) PCT Filed: Dec. 8, 2005
(86) PCT No.: PCT/US05/44516

§ 371 Date: Jul. 19, 2007

Related U.S. Application Data
(60) Provisional application No. 60/645,715, filed on Jan. 21, 2005.

(51) Int. Cl. H04N 5/91

(52) U.S. Cl. 386/68

(57) ABSTRACT

A method for skipping commercials during playback of a recorded program via an audio and/or video apparatus avoids the need to detect and record the location of the commercials at the time that the program is recorded. According to an exemplary embodiment, the method includes steps of detecting boundaries of a commercial by the audio and/or video apparatus examining program signals while playing back a program, and skipping the commercial in response to a user signal according to the detected boundaries.

### CROSS REFERENCE TO RELATED APPLICATION

This application claims priority to and all benefits accruing from a provisional application filed in the United States Patent and Trademark Office on Jan. 21, 2005, and there assigned Ser. No. 60/645,715.

### BACKGROUND OF THE INVENTION

1. Field of the Invention

The present invention generally relates to audio and/or video apparatuses, and more particularly, to a method for skipping commercials during playback of a recorded program via an audio and/or video apparatus without the need to detect and record the location of the commercials at the time that the program is recorded.

2. Background Information

Audio and/or video apparatuses such as digital video recorders (DVRs) and digital versatile disc (DVD) recording and playback devices may be used to record and playback audio and/or video content. Consumers may use such apparatuses to record and playback their favorite audio and/or video programs. During playback, however, consumers may want to avoid hearing and/or viewing certain commercials that are included with such programs. Accordingly, it is generally desirable to provide consumers with a means by which they can skip commercials during the playback of recorded programs.

One technique for skipping commercials during program playback involves locating the boundaries of each commercial when a program is being recorded. This boundary information may then be used during playback on user command to skip to the end of a block of commercials. This technique, however, is disadvantageous since it may require additional hardware support and tends to be overly complex to implement.

Another technique for skipping commercials during program playback involves the user manually entering commands during playback to advance ahead by a predetermined time period (e.g., approximately 15 or 30 seconds). However, with this technique, if the advance results in the commercial being jumped over (i.e., advancing too far beyond the end of the commercial), the user may be required to enter additional commands that cause playback to jump back by a predetermined time period (e.g., 10 seconds). This technique is disadvantageous since it may require the user to enter several commands in order to skip over a block of commercials.

Accordingly, there is a need for a method for skipping commercials during playback of a recorded program via an audio and/or video apparatus that avoids the foregoing problems, and is also capable of skipping commercials without the need to detect and record the location of the commercials at the time that the program is recorded. The present invention addresses these and/or other issues.

### SUMMARY OF THE INVENTION

In accordance with an aspect of the present invention, a method for skipping a commercial during playback of a program by an apparatus is disclosed. According to an exemplary embodiment, the method comprises steps of detecting boundaries of the commercial by the apparatus examining program signals while playing back the program, and skipping the commercial in response to a user signal according to the detected boundaries.

In accordance with another aspect of the present invention, an apparatus for skipping a commercial during playback of a program is disclosed. According to an exemplary embodiment, the apparatus comprises detecting means for detecting boundaries of the commercial by examining program signals while the program is played back, and control means for enabling the commercial to be skipped in response to a user signal according to the detected boundaries.

In accordance with another aspect of the present invention, a digital playback device is disclosed. According to an exemplary embodiment, the digital playback device comprises at least one detector operative to detect boundaries of a commercial by examining program signals while a program is played back, and a controller operative to enable the commercial to be skipped in response to a user signal according to the detected boundaries.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of an apparatus according to an exemplary embodiment of the present invention; and

FIGS. 2 to 4 are flowcharts illustrating exemplary steps for skipping commercials according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

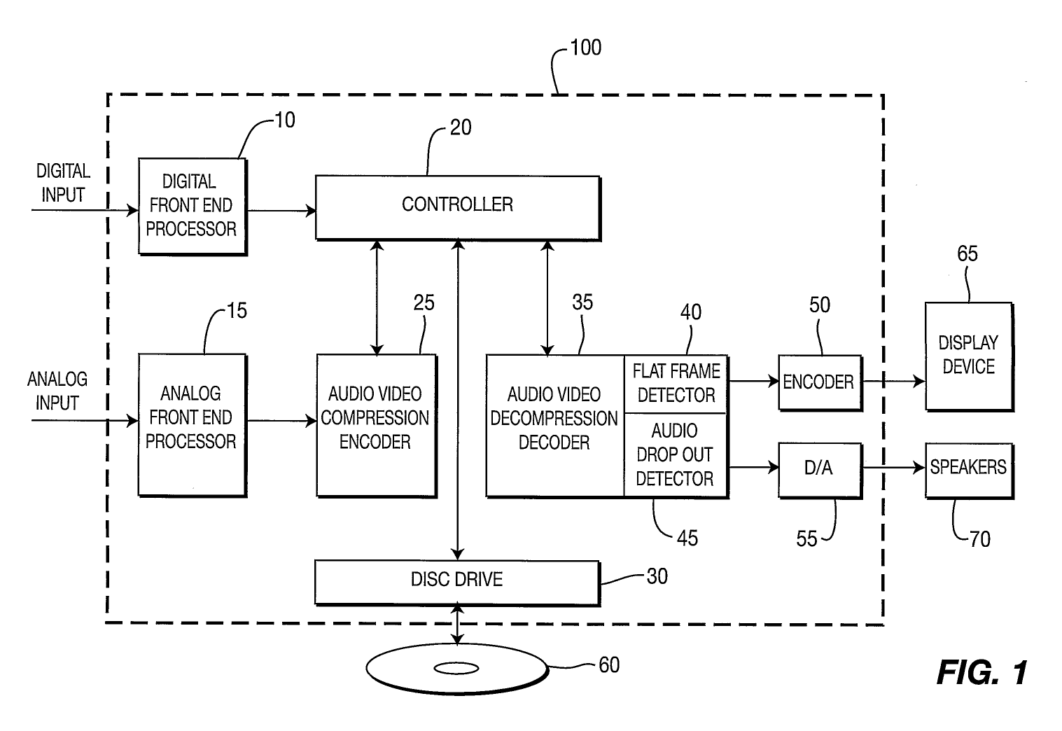

Referring now to the drawings, and more particularly to FIG. 1, a block diagram of an apparatus 100 according to an exemplary embodiment of the present invention is shown. Apparatus 100 of FIG. 1 comprises digital front end processing means such as digital front end processor 10, analog front end processing means such as analog front end processor 15, control means such as controller 20, audio and/or video compression and encoding means such as audio and/or video compression encoder 25, data recording/playback means such as disc drive 30, audio and/or video decompression and decoding means such as audio and/or video decompression decoder 35, video detecting means such as flat frame detector 40, audio detecting means such as audio drop out detector 45, encoding means such as encoder 50, and data converting means such as digital-to-analog (D/A) converter 55.

The foregoing elements of apparatus 100 may be implemented using integrated circuits (ICs), and one or more elements may be included on a given IC. Moreover, a given element may be included on more than one IC. FIG. 1 further comprises data storage means such as data storage medium 60, display means such as display device 65, and audio output means such as speakers 70. For clarity of description, certain conventional elements associated with apparatus 100 such as certain control signals, power signals and/or other elements may not be shown in FIG. 1. According to an exemplary embodiment, apparatus 100 of FIG. 1 is embodied as a digital recording and playback device such as a DVR or DVD recording and playback device. In practice, however, apparatus 100 may be implemented as any type of device, system and/or apparatus capable of playing back audio and/or video content.

Digital front end processor 10 is operative to perform digital front end processing functions of apparatus 100. According to an exemplary embodiment, digital front end processor 10 receives audio and/or video input signals having a digital modulation format (e.g., ATSC, QPSK, etc.) from one or more signal sources, and processes such input signals to thereby generate one or more digital output streams. According to this exemplary embodiment, digital front end processor 10 performs various signal processing functions including tuning, analog-to-digital (A/D) conversion, demodulation, and demultiplexing functions.

Analog front end processor 15 is operative to perform analog front end processing functions of apparatus 100. According to an exemplary embodiment, analog front end processor 15 receives input signals having an analog digital modulation format (e.g., NTSC, PAL, SECAM, etc.) from one or more signal sources, and processes such input signals to thereby generate one or more digital output streams. According to this exemplary embodiment, analog front end processor 15 performs various signal processing functions including tuning, decoding, and A/D conversion functions, and may separately generate digital video, right audio, left audio and secondary audio output streams.

Controller 20 is operative to perform processing, control and data storage functions of apparatus 100. According to an exemplary embodiment, controller 20 controls the writing and reading of audio and/or video data to and from data storage medium 60 via disc drive 30. For example, controller 20 enables compressed, digitally encoded program data from audio and/or video compression encoder 25 to be written onto data storage medium 60 via disc drive 30. Controller 20 also provides the digital output streams from digital front end processor 10 to audio and/or video compression encoder 25 for compression and encoding prior to being written onto data storage medium 60 via disc drive 30. Controller 20 also receives audio and/or video data read from data storage medium 60 via disc drive 30, and provides this read data to audio and/or video decompression decoder 35 for decompression and decoding, and ultimately presentation to the user.

Controller 20 also enables commercial skipping according to principles of the present invention. According to an exemplary embodiment, controller 20 determines whether commercial boundaries are present based on feedback signals provided from flat frame detector 40 and audio drop out detector 45 that indicate whether a commercial boundary has been detected. Further details regarding the functionality of flat frame detector 40 and audio drop out detector 45 will be provided later herein. According to another exemplary embodiment, controller 20 is operative to detect commercial boundaries by examining digitally encoded signals read from data storage medium 60 via disc drive 30. When a commercial boundary is detected, controller 20 records data in an internal memory (not shown in FIG. 1) to indicate the boundary (e.g., location) of the detected commercial. In this manner, controller 20 keeps track of commercial boundaries as they occur during the playback of programs recorded on data storage medium 60. Controller 20 also provides control signals which cause disc drive 30 to advance playback (i.e., jump forward on data storage medium 60) in order to skip commercials in accordance with the detected commercial boundaries. Further details regarding commercial skipping according to the present invention will be provided later herein.

Audio and/or video compression encoder 25 is operative to perform audio and/or video compression and encoding functions of apparatus 100. According to an exemplary embodiment, audio and/or video compression encoder 25 compresses and encodes audio and/or video provided from digital front end processor 10 via controller 20, as well as audio and/or video data provided from analog front end processor 15 to thereby generate compressed, digitally encoded data.

Disc drive 30 is operative to provide an interface between apparatus 100 and a data storage medium, such as data storage medium 60. According to an exemplary embodiment, disc drive 30 is operative to write and read audio and/or video data to and from data storage medium 60 responsive to control signals from controller 20.

Audio and/or video decompression decoder 35 is operative to perform audio and/or video decompression decoding functions of apparatus 100. According to an exemplary embodiment, audio and/or video decompression decoder 35 decompresses and decodes digital audio and/or video data provided via controller 20 to thereby generate decompressed, decoded digital data.

Flat frame detector 40 is operative to perform a flat frame detection function of apparatus 100. According to an exemplary embodiment, flat frame detector 40 examines decompressed and decoded video program signals provided from audio and/or video decompression decoder 35 to determine whether a black or flat video frame is detected. According to this exemplary embodiment, a black or flat video frame is a video frame whose picture elements (e.g., pixels, pels, etc.) all have substantially the same values. Flat frame detector 40 may provide a feedback signal to controller 20 to indicate that a black or flat video frame has been detected, indicating a potential commercial boundary.

Audio drop out detector 45 is operative to perform an audio drop out function of apparatus 100. According to an exemplary embodiment, audio drop out detector 45 examines decompressed and decoded audio program signals provided from audio and/or video decompression decoder 35 to determine whether an audio drop out condition is present. According to this exemplary embodiment, an audio drop out condition occurs when the audio level is below a predetermined threshold level for a predetermined time period, indicating a potential commercial boundary. The selection of this predetermined threshold and predetermined time period may be selected as a matter of design choice.

Encoder 50 is operative to perform an encoding function of apparatus 100. According to an exemplary embodiment, encoder 50 performs a video encoding function (e.g., NTSC encoding, PAL encoding, SECAM encoding, etc.) on video output signals provided from flat frame detector 40 to thereby generate encoded video output signals.

D/A converter 55 is operative to perform a digital-to-analog conversion function of apparatus 100. According to an exemplary embodiment, D/A 55 converts digital audio signals provided from audio drop out detector 45 to analog audio output signals.

Data storage medium 60 is operative to store data including digital audio and/or video data. According to an exemplary embodiment, data storage medium 60 may be embodied as a DVD, hard disc, or other type of data storage medium that is capable of storing digital audio and/or video data.

Display device 65 is operative to provide visual outputs responsive to the encoded video output signals provided by encoder 50. Speakers 70 are operative to provide aural outputs responsive to the audio output signals provided by D/A 55.

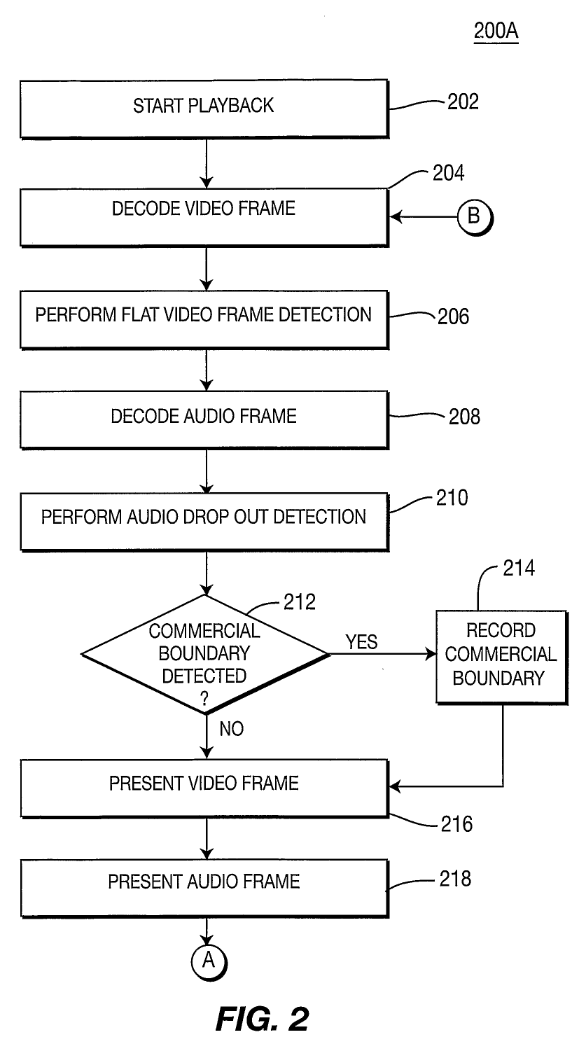

Referring to FIGS. 2 to 4, flowcharts 200A to 200C illustrating steps for skipping commercials according to an exemplary embodiment of the present invention are shown. For purposes of example and explanation, the steps of FIGS. 2 to 4 will be described with reference to the elements of FIG. 1 including apparatus 100. Also for purposes of example and explanation, the steps of FIGS. 2 to 4 refer to specific time periods including 15 and 30 second time periods. These exemplary time periods are based on the assumption that a given commercial may be approximately 15 or 30 seconds in duration. However, different time periods may also be used in practicing the steps of FIGS. 2 to 4. Accordingly, the steps of FIGS. 2 to 4 are exemplary only, and are not intended to limit the present invention in any manner.

At step 202, the playback process for a recorded program starts. According to an exemplary embodiment, apparatus 100 starts to playback a recorded program on data storage medium 60 under the control of controller 20 at step 202 in response to a predetermined user input (e.g., “PLAY” command, etc.). The recorded program may have been recorded onto data storage medium 60 via apparatus 100, or by another device, system or apparatus capable of data recording.

At step 204, a video frame is decoded. According to an exemplary embodiment, disc drive 30 reads program signals for the video frame from data storage medium 60, and provides the read program signals to audio and/or video decompression decoder 35 for decoding under the control of controller 20 at step 204.

At step 206, a flat video frame detection process is performed. According to an exemplary embodiment, flat frame detector 40 performs step 206 by examining program signals for the video frame decoded at step 204 to determine whether the video frame represents a black or flat video frame. According to this exemplary embodiment, a black or flat video frame is a video frame whose picture elements (e.g., pixels, pels, etc.) all have substantially the same values.

At step 208, an audio frame is decoded. According to an exemplary embodiment, disc drive 30 reads program signals for the audio frame from data storage medium 60, and provides the read program signals to audio and/or video decompression decoder 35 for decoding under the control of controller 20 at step 208. Steps 204 and 208 may be performed simultaneously, or substantially simultaneously.

At step 210, an audio drop out detection process is performed. According to an exemplary embodiment, audio drop out detector 45 performs step 210 by examining program signals for the audio frame decoded at step 208 to determine whether the program signals indicate an audio drop out condition. According to this exemplary embodiment, an audio drop out condition occurs when the audio level is below a predetermined threshold level for a predetermined time period. The selection of this predetermined threshold and predetermined time period may be selected as a matter of design choice. Steps 206 and 210 may be performed simultaneously, or substantially simultaneously.

At step 212, a determination is made as to whether a commercial boundary is detected from the flat video frame detection process of step 206 and the audio drop out detection process of step 210. According to an exemplary embodiment, controller 20 makes the determination at step 212 based on feedback signals provided from flat frame detector 40 and audio drop out detector 45 that indicate the results of the flat video frame detection process of step 206 and the audio drop out detection process of step 210, respectively.

If the determination at step 212 is positive, process flow advances to step 214 where the detected commercial boundary is recorded. According to an exemplary embodiment, controller 20 records data in an internal memory (not shown in FIG. 1) at step 214 to indicate the boundary (e.g., location) of the detected commercial.

If the determination at step 212 is negative, process flow advances to step 216 where the video frame decoded at step 204 is presented to the user via display device 65. From step 216, process flow advances to step 218 where the audio frame decoded at step 208 is aurally presented to the user via speakers 70. According to an exemplary embodiment, steps 216 and 218 are performed simultaneously, or substantially simultaneously, so that the user is presented with time-aligned video and audio content.

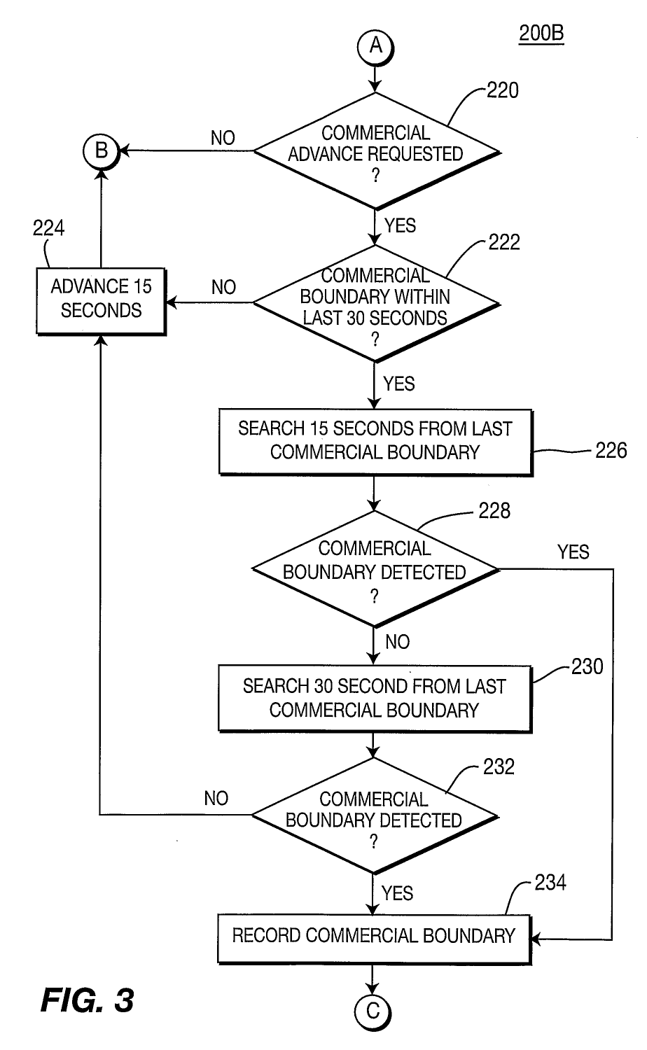

From step 218, process flow advances to step 220 (see flowchart 200B of FIG. 3) where a determination is made as to whether a commercial advance is requested by the user. According to an exemplary embodiment, controller 20 detects whether a predetermined user input signal representing a commercial advance request is received at step 220.

If the determination at step 220 is negative, process flow loops back to step 204 (see flowchart 200A of FIG. 2), where another video frame is decoded as previously described. Process flow proceeds from step 204 in the previously described manner.

If the determination at step 220 is positive, process flow advances to step 222 where a determination is made as to whether a commercial boundary has been detected within the last 30 seconds of playback. According to an exemplary embodiment, controller 20 makes the determination at step 222 by examining data in its internal memory that indicates the location of the last detected commercial boundary. From this location, controller 20 may perform calculations to determine whether this boundary was detected within the last 30 seconds of playback.

If the determination at step 222 is negative, process flow advances to step 224 where playback is advanced by approximately 15 seconds. According to an exemplary embodiment, controller 20 provides one or more control signals to disc drive 30 which cause it to advance playback (i.e., jump forward on data storage medium 60) by approximately 15 seconds. From step 224, process flow loops back to step 204 (see flowchart 200A of FIG. 2) where another Video frame is decoded and process flow proceeds from step 204 in the previously described manner.

If the determination at step 222 is positive, process flow advances to step 226 where apparatus 100 searches for a commercial boundary approximately 15 seconds ahead of the last detected commercial boundary. According to an exemplary embodiment, controller 20 enables the performance of step 226 by providing one or more control signals to disc drive 30 which cause it to begin reading program signals from data storage medium 60 at a location approximately 15 seconds ahead of the last detected commercial boundary. These read program signals are provided to audio and/or video decompression decoder 35 for decoding under the control of controller 20. Flat frame detector 40 then examines the decompressed and decoded video program signals provided from audio and/or video decompression decoder 35 to determine whether a black or flat video frame is detected at a location approximately 15 seconds ahead of the last detected commercial boundary. As previously indicated herein, a black or flat video frame is a video frame whose picture elements (e.g., pixels, pels, etc.) all have substantially the same values. Audio drop out detector 45 also examines the decompressed and decoded audio program signals provided from audio and/or video decompression decoder 35 to determine whether an audio drop out condition is detected at a location approximately 15 seconds ahead of the last detected commercial boundary. As previously indicated herein, an audio drop out condition occurs when the audio level is below a predetermined threshold level for a predetermined time period. In the aforementioned manner, the flat video frame detection process of flat frame detector 40 and the audio drop out detection process of audio drop out detector 45 are used to search for a commercial boundary approximately 15 seconds ahead of the last detected commercial boundary at step 226.

From step 226, process flow advances to step 228 where a determination is made as to whether a commercial boundary is detected from the searching performed at step 226. According to an exemplary embodiment, controller 20 makes the determination at step 228 based on feedback signals provided from flat frame detector 40 and audio drop out detector 45 that indicate the results of the flat video frame detection process and the audio drop out detection process performed during the searching of step 226. It is noted that steps 226 and 228 may be skipped if playback has advanced more than 15 seconds beyond the last detected commercial boundary at the time the commercial advance request is received at step 220.

If the determination at step 228 is positive, process flow advances to step 234 where the detected commercial boundary is recorded. According to an exemplary embodiment, controller 20 records data in an internal memory (not shown in FIG. 1) at step 234 to indicate the boundary (e.g., location) of a detected commercial.

If the determination at step 228 is negative, process flow advances to step 230 where apparatus 100 searches for a commercial boundary approximately 30 seconds ahead of the last detected commercial boundary. According to an exemplary embodiment, the boundary search of step 230 may be performed in a similar manner as the previously described boundary search of step 226. Accordingly, the flat video frame detection process of flat frame detector 40 and the audio drop out detection process of audio drop out detector 45 may be used to search for a commercial boundary approximately 30 seconds ahead of the last detected commercial boundary at step 230.

From step 230, process flow advances to step 232 where a determination is made as to whether a commercial boundary is detected from the searching performed at step 230. According to an exemplary embodiment, controller 20 makes the determination at step 232 based on feedback signals provided from flat frame detector 40 and audio drop out detector 45 that indicate the results of the flat video frame detection process and the audio drop out detection process performed during the searching of step 230.

If the determination at step 232 is negative, process flow loops back to step 224 where playback is advanced by approximately 15 seconds in the previously described manner. If the determination at step 232 is positive, process flow advances to step 234 where the detected commercial boundary is recorded by controller 20 in the previously described manner.

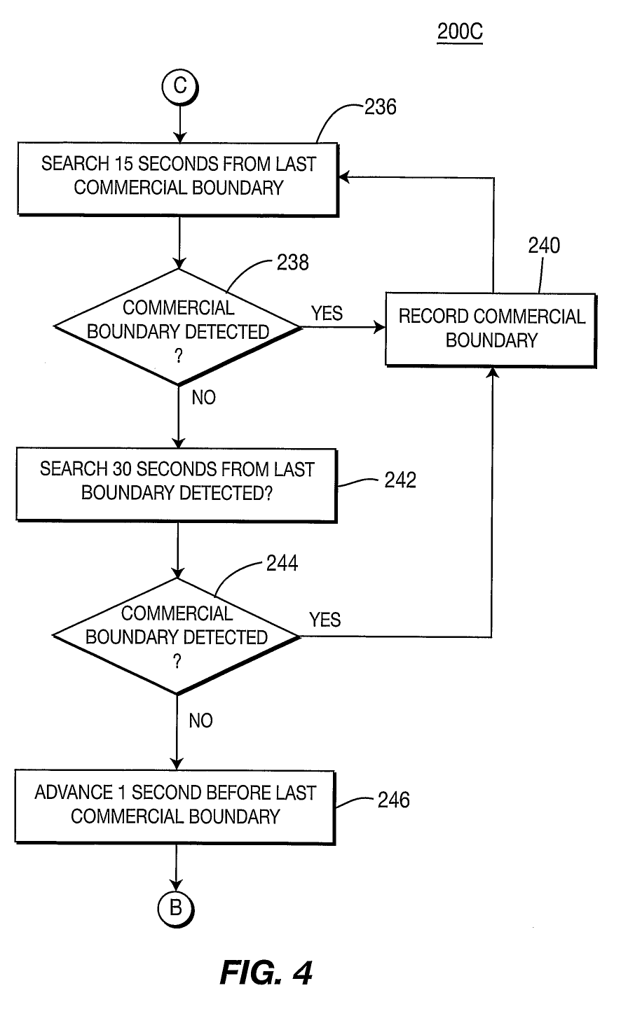

From step 234, process flow advances to step 236 (see flowchart 200C of FIG. 4) where apparatus 100 searches for a commercial boundary approximately 15 seconds ahead of the last detected commercial boundary. According to an exemplary embodiment, the boundary search of step 236 may be performed in a similar manner as the previously described boundary search of step 226. Accordingly, the flat video frame detection process of flat frame detector 40 and the audio drop out detection process of audio drop out detector 45 may be used to search for a commercial boundary approximately 15 seconds ahead of the last detected commercial boundary at step 236.

From step 236, process flow advances to step 238 where a determination is made as to whether a commercial boundary is detected from the searching performed at step 236. According to an exemplary embodiment, controller 20 makes the determination at step 238 based on feedback signals provided from flat frame detector 40 and audio drop out detector 45 that indicate the results of the flat video frame detection process and the audio drop out detection process performed during the searching of step 236.

If the determination at step 238 is positive, process flow advances to step 240 where the detected commercial boundary is recorded by controller 20 in the previously described manner. If the determination at step 238 is negative, process flow advances to step 242 where apparatus 100 searches for a commercial boundary approximately 30 seconds ahead of the last detected commercial boundary. According to an exemplary embodiment, the boundary search of step 242 may be performed in a similar manner as the previously described boundary search of step 230. Accordingly, the flat video frame detection process of flat frame detector 40 and the audio drop out detection process of audio drop out detector 45 may be used to search for a commercial boundary approximately 30 seconds ahead of the last detected commercial boundary at step 242.

From step 242, process flow advances to step 244 where a determination is made as to whether a commercial boundary is detected from the searching performed at step 242. According to an exemplary embodiment, controller 20 makes the determination at step 244 based on feedback signals provided from flat frame detector 40 and audio drop out detector 45 that indicate the results of the flat video frame detection process and the audio drop out detection process performed during the searching of step 242.

If the determination at step 244 is positive, process flow loops back to step 240 where the detected commercial boundary is recorded by controller 20 in the previously described manner. If the determination at step 244 is negative, process flow advances to step 246 where apparatus 100 advances to a location approximately 1 second before the last detected commercial boundary. According to an exemplary embodiment, controller 20 provides one or more control signals to disc drive 30 which cause it to advance (i.e., jump forward on data storage medium 60) to a location approximately 1 second before the last detected commercial boundary at step 246. From step 246, process flow loops back to step 204 (see flowchart 200A of FIG. 2) where another video frame is decoded and process flow proceeds from step 204 in the previously described manner.

Variations of the steps of FIGS. 2 to 4 are also within the scope of the present invention. For example, the flat video frame detection process of flat frame detector 40 and the audio drop out detection process of audio drop out detector 45 may be performed such that the audio drop out detection process is performed only if the flat video frame detection process first indicates the presence of a commercial boundary. Conversely, the flat video frame detection process may be performed only if the audio drop out detection process first indicates the presence of a commercial boundary. In this manner, either the flat video frame detection process of flat frame detector 40 or the audio drop out detection process of audio drop out detector 45 may be used as a primary technique for detecting commercial boundaries, and the other process may be used as a secondary technique to confirm the presence of commercial boundaries. Other variations may also exist.

As described herein, the present invention provides a method for skipping commercials during playback of a recorded program via an audio and/or video apparatus without the need to detect and record the location of the commercials at the time that the program is recorded.

The present invention may be applicable to various apparatuses, either with or without an integrated display device. For example, the present invention may be applicable to apparatuses such as, but not limited to, television sets, computers, monitors or radios that include an integrated display device, and apparatuses such as set-top boxes, video cassette recorders (VCRs), DVD players, video game boxes, DVRs, radios, computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for skipping a commercial during playback of a program by an apparatus, said method comprising steps of:
detecting boundaries of said commercial by said apparatus examining program signals while playing back said program; and
skipping said commercial in response to a user signal according to said detected boundaries.

2. The method of claim 1, wherein said detecting step comprises steps of:
detecting a first boundary while said apparatus plays back said program; and
detecting a second boundary in response to said user signal by said apparatus examining said program signals located after said first boundary.

3. The method of claim 2, wherein said first and second boundaries are detected by said apparatus examining video components of said program signals.

4. The method of claim 3, wherein said first and second boundaries are detected by said apparatus detecting video frames each of whose picture elements all have substantially the same values.

5. The method of claim 2, wherein said first and second boundaries are detected by said apparatus examining audio components of said program signals.

6. The method of claim 5, wherein said first and second boundaries are detected by said apparatus detecting audio frames that indicate an audio level below a threshold for a first time period.

7. The method of claim 2, wherein said skipping step includes skipping playback of said program signals from when said user signal is received by said apparatus to a first time period before said second boundary.

8. The method of claim 7, further comprising a step of presenting program content after said first boundary is detected and before said user signal is received by said apparatus.

9. An apparatus for skipping a commercial during playback of a program, said apparatus comprising:
detecting means for detecting boundaries of said commercial by examining program signals while said program is played back; and
control means enabling said commercial to be skipped in response to a user signal according to said detected boundaries.

10. The apparatus of claim 9, wherein said detecting means detects a first boundary while said program is played back, and detects a second boundary in response to said user signal by examining said program signals located after said first boundary.

11. The apparatus of claim 10, wherein said detecting means includes a first detector for detecting said first and second boundaries by examining video components of said program signals.

12. The apparatus of claim 11, wherein said first detector detects said first and second boundaries by detecting video frames each of whose picture elements all have substantially the same values.

13. The apparatus of claim 10, wherein said detecting means includes a second detector for detecting said first and second boundaries by examining audio components of said program signals.

14. The apparatus of claim 13, wherein said second detector detects said first and second boundaries by detecting audio frames that indicate an audio level below a threshold for a first time period.

15. The apparatus of claim 10, wherein said control means enables said commercial to be skipped by skipping playback of said program signals from when said user signal is received to a first time period before said second boundary.

16. The apparatus of claim 15, wherein said control means enables presentation of program content after said first boundary is detected and before said user signal is received.

17. A digital playback device, comprising:
at least one detector operative to detect boundaries of a commercial by examining program signals while a program is played back; and
a controller to enable said commercial to be skipped in response to a user signal according to said detected boundaries.

18. The digital playback device of claim 17, wherein said at least one detector detects a first boundary while said program is played back, and detects a second boundary in response to said user signal by examining said program signals located after said first boundary.

19. The digital playback device of claim 18, wherein said at least one detector includes a first detector for detecting said first and second boundaries by examining video components of said program signals.

20. The digital playback device of claim 19, wherein said first detector detects said first and second boundaries by detecting video frames each of whose picture elements all have substantially the same values.

21. The digital playback device of claim 18, wherein said at least one detector includes a second detector for detecting said first and second boundaries by examining audio components of said program signals.

22. The digital playback device of claim 21, wherein said second detector detects said first and second boundaries by detecting audio frames that indicate an audio level below a threshold for a first time period.

23. The digital playback device of claim 18, wherein said controller enables said commercial to be skipped by skipping playback of said program signals from when said user signal is received to a first time period before said second boundary.

24. The digital playback device of claim 23, wherein said controller enables presentation of program content after said first boundary is detected and before said user signal is received.
